(19) United States
(12) Patent Application Publication
(10) Pub. No.: US 2005/0010916 A1
(43) Pub. Date: Jan. 13, 2005

(54) System for providing software application updates to multiple clients on a network

(76) Inventors: David A. Hagen, Southern Pines, NC (US); Rick Stefanik, Pinehurst, NC (US)

Correspondence Address: SMITH MOORE LLP, P.O. BOX 21927, GREENSBORO, NC, 27420, US

(21) Appl. No.: 10/852,583

(22) Filed: May 24, 2004

Related U.S. Application Data
(60) Provisional application No. 60/473,105, filed on May 24, 2003.

(51) Int. Cl. G06F 9/44

(52) U.S. Cl. 717/170; 717/171

(57) ABSTRACT

System for providing software application updates to multiple clients on a network including a server component and a client component. The version of the software application on the client component is compared with the version of the application stored on the server component to determine whether the client's version is outdated. If an update is necessary, a first data transmission channel is established between the client and server components and the client recursively works through each file of the software application and sends a cyclical redundancy check (CRC) to the server for each file. The server recursively compares each CRC from the client with the equivalent file on the server to determine which files need to be updated or deleted. A second data transmission channel is established to transmit any updates to the client component.

This application claims the benefit of U.S. Provisional Application No. 60/473,105, filed on May 24, 2003.

### BACKGROUND OF THE INVENTION

The present invention relates to a system for providing software application updates to multiple clients on a network.

Generally, software applications stored on client-server networks are constantly being updated or revised. Whenever these changes are made, the changes must be distributed to each client on the network. In the past, whenever one file in a plurality of files comprising a software application was updated, each file of the software application had to be downloaded to each client computer, including the files that had not been changed. This system was obviously inefficient for various reasons. One attempt at solving this problem is the ability to redownload only the file that had been modified. This process, however, is still inefficient and burdensome when only a small part of a file may have been revised.

Accordingly, there is a need in the art for an update system that systematically and efficiently updates the files of a software application.

### SUMMARY OF THE PRESENT INVENTION

A method for providing software updates to multiple client computers on a network including the steps of altering at least one file of a software application stored on a server computer on a network, sending an application status request from a client computer on the network to the server computer, the server computer responding to the application status request from the client computer with indicia identifying the version of the software application that is stored on the server computer, comparing the indicia identifying the version of the software application that is stored on the server computer with indicia identifying the version of the software application that is stored on the client computer, sending a software update request to the server computer if it is determined that the version of the software application stored on the client computer is outdated as compared to the version of the software application stored on the client computer, establishing a first data transmission channel between the client computer and the server computer, the client computer recursively working through each file of the software application stored on the client computer and sending a CRC to the server computer for each file, the server computer recursively comparing the CRC for each file of the software application from the client computer to the equivalent file of the software application stored on the server computer, the server computer sending a notification to the client computer on whether each reviewed file of the software application on the client computer needs to be updated or deleted based on the CRC comparison, and establishing a second data transmission channel between the client computer and the server computer for updating the files of the software application that are determined to need updating.

### DETAILED DESCRIPTION OF THE PREFERRED EMBODIMENTS

The present invention provides an improved system for providing software updates to multiple clients on a network. The update system comprises an update component that includes a server component and a client component. Together, these components are configured to update a software application on a client computer to match the equivalent set of files on a server on the network.

The process begins when at least one file of a software application is modified or altered and stored on the server. When the client component requests a status check on the most current version of the application, the request is sent to a central load distributor or transmission node on the virtual local access network (VLAN) which responds to the client component with indicia such as the most current version number of the software and the number of milliseconds left until the next version of the software should be applied. These version numbers are compared to the version number of the currently stored application to determine whether the current version of the application is out of date.

If the current version of the application is outdated, the application requests an update via the client component. In particular, the client may need the most current version of the software or it may need to begin transferring the next version ahead of time so that it can implement the new version at the appropriate time. This feature is particularly useful when dealing with different time zones and balancing the load temporally so that there is less need for huge, massive servers with lots of bandwidth. When the latter is the case, the client component starts a timer that notifies the client when to implement the next version.

In the first embodiment, where the request for an update is sent to a central load distributor, the client component requests a list of update servers from the central load distributor. The central load distributor comprises a plurality of update servers on the network that are available to accept update requests from the plurality of client components. These update servers comprise logical switches that operate as a central routing site and serve as the entry point into the system. The update request from the client component attempts to connect to several update servers at one time, however, the update servers assist the portals with selecting the best one by varying their response to incoming requests. Particularly, each update server is configured to sleep before responding to a request as its performance level degrades. Correspondingly, each update server is configured to decrease its response delay as its performance level improves. Each update server is further configured to reject connections if its performance level reaches critical levels. The closest update server to the requesting client is contacted by the client component based on its connection time but the best performing update server is selected by adding the performance delay to that connection time. Therefore, the client connects to the closest, best performing update server, which is the first update server to respond to the request. The system accordingly provides efficient global load balancing and prevents any one update server from becoming overloaded with requests.

In the second embodiment, where the request for an update is sent to a transmission node on a VLAN, the client connects to the quickest and best other node on the network, regardless of whether that node is a another peer or a designated update server. More specifically, each client on the VLAN that requests the software update is considered a peer node on the VLAN. The first peer to request the update becomes a transmission node on the VLAN when it is capable of transmitting the update to other nodes on the network. All of the peers and update servers are connected to one another so that each request is processed by the quickest and best source. Thus, this embodiment also provides for efficient global load balancing.

Once the client component connects to an update server or transmitting node, and a data transmission channel is established, the new version of the software to be distributed is sent to the update server or transmitting node so that the correct working directory can be utilized by the server component. The correct working directory and version indicia is also passed to the client and server components so that both components are prepared for the data transfer.

The client component then sends its concurrent file limit to the server. This limit is compared to the server component concurrent file limit. The smallest number is preferably used to limit the number of files that are simultaneously updated. The expected total number of bytes in the update is also passed to the client component so that progress can be reported as accurately as possible.

The client component then recursively works through all of the files of the application in the working directory and any subdirectories. For each file, a Cyclical Redundancy Check (CRC) is generated and the relative path, filename, and CRC are sent to the server component. The server component compares this CRC to the equivalent file on the server and marks that file as being verified for the client. A response is then sent to the client indicating if this file will be updated or if the client component should mark this file for deletion. Files marked for deletion are not actually deleted from the working directories so that cancelled updates can still operate correctly. Instead, deletions are tracked by the client component and returned at the end of the process. If the CRC does not match, a new data transmission channel is created to begin updating that file. Once an acknowledgement is received, the client component calculates the next file's CRC and sends that to the server, continuing until all files in the working directory have been sent.

Once a file update is spawned, it is entered into a queue of required file updates. This queue can grow as needed, but only the previously negotiated number of files is updated simultaneously. For each file update, two separate channels are established between the server component and the client component. The server component then utilizes a negotiation channel to send the block size that will be used and the CRC values for each block.

The block size used for each file is adjusted after each transmission. The number of bytes transferred for each file is tracked, including CRCs, negotiations, and actual data blocks. This byte count is compared to the byte count of the previous transmission of that same file. If the current byte count is greater, the direction is reversed. If the byte count is the same or less, the block size is preferably adjusted by 50 bytes, or more or less based on the current direction. The block size for a new file preferably always begins at a predetermined byte size, such as 1000 bytes.

For each CRC value received, the client component searches for matching CRCs in the local file using a rolling CRC method. If no match is found, the client component indicates to the server component that the specified block is required. This block is then sent over a separate data channel so that it does not interfere with the CRC checks. If a match is found, a strong CRC is generated for that block and is sent back to the server component. The strong CRC is then generated on the server and compared. An indication is sent back to the client component indicating whether the CRC matched. If not, the weak CRC check is continued. If a match is found, the client component utilizes the block found locally as the block of the server file being checked.

Once all of the files are checked, the client component sends a message indicating completion of the CRC check. The server component then adds any files to the update queue that were not compared and therefore did not exist in the client working directory. New files do not utilize this CRC based differential update process since there is no existing file on the client machine to compare. Rather, new files are written to the appropriate location in the working directory.

An update script is transmitted as a part of each update process. The script has three parts. The first is a script that assembles the working directory. The second is an “update” script that takes the updated working directory and copies the new files to the proper places. The third script is a cancel update script which handles any clean up if the update is interrupted. This feature handles updating registry settings (on windows) and updating system files that may not be in the program's main directory. When the “done” event is triggered, it is this script that handles the file piece of the update.

Once the entire update process is complete, an event is triggered on both the client and server components indicating that the transfer of the working directory is complete and the client component passes the list of files marked for deletion. These files may be deleted one at a time by the application, thereby ensuring that any client files in the application directories are unaffected by the update. Preferably, the application determines which subdirectories should not be deleted. The client component then marks any file in the working directory that is not present on the server side as a deletion.

This update process can be cancelled by the application at any time. This causes the update component to stop all file transfers and comparisons and delete any partially transmitted files. Any completed files are left untouched. The application can then initiate a new update process through the client component at any time. The newly initiated file comparison causes previously updated files to be skipped and the update to continue where it left off. The list of files marked for deletion is erased prior to starting the new update. Since these files are not actually deleted, they also appear on a subsequent list of deleted files.

The update servers and peer nodes on the network periodically request from the central load distributor or transmitting node a list of version numbers that the update servers and peer nodes should be supporting. If any version in the list is not available, it is acquired. Along with each version number, the central load distributor or transmitting node returns the IP address of a central update server or other peer node that will be distributing the update and a working directory that should be created locally. The update server or node then uses the client component to obtain the specified update. This update server's or transmitting node's IP address is then utilized for any future update request versions for that version number.

Certain modifications and improvements will occur to those skilled in the art upon a reading of the forgoing description. All such modifications and improvements of the present invention have been deleted herein for the sake of conciseness and readability but are properly within the scope of the present invention.

1. A method for providing software updates to multiple client computers on a network comprising the steps of:
altering at least one file of a software application stored on a server computer on a network;
sending an application status request from a client computer on the network to the server computer;
the server computer responding to the application status request from the client computer with indicia identifying the version of the software application that is stored on the server computer;
comparing the indicia identifying the version of the software application that is stored on the server computer with indicia identifying the version of the software application that is stored on the client computer;
sending a software update request to the server computer if it is determined that the version of the software application stored on the client computer is outdated as compared to the version of the software application stored on the client computer;
establishing a first data transmission channel between the client computer and the server computer;
the client computer recursively working through each file of the software application stored on the client computer and sending a cyclical redundancy check (CRC) to the server computer for each file;
the server computer recursively comparing the CRC for each file of the software application from the client computer to the equivalent file of the software application stored on the server computer;
the server computer sending a notification to the client computer on whether each reviewed file of the software application on the client computer needs to be updated or deleted based on the CRC comparison; and
establishing a second data transmission channel between the client computer and the server computer for updating the files of the software application that are determined to need updating.

2. The method of claim 1 further comprising the step of the server computer responding to the application status request from the client computer with indicia identifying when the version of the software application that is stored on the server computer should be implemented on the client computer.

3. The method of claim 1 wherein further comprising the steps of the server computer sending a notification to the client computer regarding software application files that need to be added to the software application stored on the client computer and writing said files to a working directory on the client computer.

4. The method of claim 1 wherein each software application file update further comprises a plurality of scripts for assembling an updated working directory on the client computer, copying new files to appropriate locations in the working directory, and cleaning up files in the working directory in the case that an update process is cancelled.
